(19) United States
(12) Patent Application Publication
(10) Pub. No.: US 2008/0311990 A1
(43) Pub. Date: Dec. 18, 2008

(54) POSITION SYSTEM FOR INTERACTIVE GAMING DEVICE AND METHOD USING THE SAME

(75) Inventors: Shuo-Tsung Chiu, Taipei Hsien (TW); Wen-Cheng Hsu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 11/762,294

(22) Filed: Jun. 13, 2007

(51) Int. Cl. A63F 13/06

(52) U.S. Cl. 463/37

(57) ABSTRACT

A position system for interactive gaming device has a main apparatus and a wireless controller. The main apparatus has a first ultrasonic receiving module, a second ultrasonic receiving module and a third ultrasonic receiving module. The three ultrasonic receiving modules are arranged as a triangle shape. The wireless controller has an ultrasonic transmitting module. The ultrasonic transmitting module of the wireless controller sends an ultrasonic wave which is received by the ultrasonic receiving modules in order to obtain three ultrasonic wave transmission times. The main apparatus calculates the received transmission time and therefore recognizes the position of the wireless controller. When the wireless controller is moved, the main apparatus obtains a plurality of coordinate values indicating the motion track of the wireless controller. In this case, an electronic device shows the movement of the wireless controller on a display device by monitoring the coordinate values.

### BACKGROUND OF THE INVENTION

1. Field of the Invention

The present invention relates to a position system for interactive gaming device and method using the same, and more particularly to a position system for positioning a wireless controller of the interactive gaming device and method using the same.

2. The Related Art

Nowadays, more and more people are amused by varieties of video games or computer games. Taking a computer game for example, conventionally, if a player wants to play the computer game, he firstly has to install game software in a host of a computer. The player controls the game process by peripherals of the computer, such as a mouse, a keyboard, a control handle or the like. All of which connect with the computer. The game process and game information are displayed to the player through a monitor and a speaker or other multimedia output devices. However, as continuous development of technology, interactive gaming devices are provided to the player accompanying with the game software.

One example of the interactive gaming devices is disclosed in U.S. patent public No. 2007/0072674 issued Jan. 2, 2006. The interactive gaming device includes a host apparatus connected to a home-use TV receiver via a connection cord, a wireless controller for giving operation data to the host apparatus, and a pair of infrared markers provided on top of the TV receiver and on both sides of the TV receiver. Each infrared marker outputs infrared light forward. The host apparatus is connected to a receiving unit via a connection terminal. The receiving unit is used for receiving operation data that is wirelessly transmitted from the wireless controller.

The wireless controller includes an operation section, an imaging information calculation section, a communication section and an acceleration sensor. The operation section includes a plurality of operation buttons defined in a housing of the wireless controller, which the player can use to perform the game process. The imaging information calculation section includes an infrared filter, a lens, an imaging element and an image processing circuit. The infrared filter allows only infrared light to pass therethrough. The lens collects the infrared light which has passed through the infrared filter and outputs the infrared light to the imaging element. The imaging element is a solid-state imaging device such as, a CMOS sensor or a CCD. The imaging element takes an image of the infrared light which has passed through the infrared filter and been collected by the lens, and generates image data. The image data is processed by the image processing circuit. The image processing circuit calculates the positions of the infrared markers in the taken image, and outputs coordinate sets to the communication section.

The acceleration sensor detects acceleration in three axial directions of the wireless controller, i.e., the up-down direction, the left-right direction and the front-rear direction. The acceleration sensor allows the inclinations of the wireless controller in the three axial directions to be determined. In addition to the taken image mentioned above, the wireless control determines the acceleration and inclination thereof via the acceleration sensor.

The communication section includes a microcomputer, a memory, a wireless module and an antenna. The microcomputer receives the data which is output from the operation section, the acceleration sensor, and the imaging information calculation circuit and stores the data in the memory. The wireless module and the antenna transmit the data stored in the memory to the host apparatus by a wireless technology. The data includes the displacement direction, the inclination and the acceleration of the wireless controller.

The host apparatus uses the receiving unit to receive the operation data from the wireless controller in a way of wireless transmission and executes the game process based on the obtained operation data.

The interactive gaming device makes use of the imaging information calculation section to collect and calculate the positions of the two infrared markers, and simultaneously uses the acceleration sensor to attain the data of the inclination and the acceleration of the wireless controller. Then, the communication section transmits the data of the displacement direction, the inclination and the acceleration of the wireless controller to the host apparatus to be processed. It can be seen that the interactive gaming device should provide the imaging information calculation section and the acceleration sensor to position the wireless controller. So the manufacture cost of the interactive gaming device is increased. Further more, if the environment around the infrared markers brings infrared interference, the imaging information calculation section will not attain the positions of the two infrared markers exactly. Therefore, the game can't go on.

Hence, an improved interactive gaming device is desired to overcome the shortcomings described above.

### SUMMARY OF THE INVENTION

Accordingly, an object of the present invention is to provide a position system for positioning a wireless controller of an interactive gaming device. The position system includes a main apparatus and a wireless controller. The main apparatus includes a first ultrasonic receiving module, a second ultrasonic receiving module, a third ultrasonic receiving module, a first communication module and a first antenna. The wireless controller includes an ultrasonic transmitting module, a second communication module and a second antenna. The first ultrasonic receiving module has a distance from the second ultrasonic receiving module, and the third ultrasonic receiving module has a distance from the first ultrasonic receiving module and the second ultrasonic receiving module. The three ultrasonic receiving modules form a triangle shape. The three ultrasonic receiving modules receive ultrasonic signals sent by the ultrasonic transmitting module of the wireless controller in order that the main apparatus calculates the received transmission times of the ultrasonic signals and obtains a plurality of coordinate values indicating the motion track of the wireless controller, and further recognizes the positions of the wireless controller. The main apparatus and the wireless controller transmit data to each other with the help of the first communication module, the first antenna, the second communication module and the second antenna.

The other object of the present invention is to provide a method for positioning the wireless controller of the interactive gaming device, comprising the steps of: sending out a prepared position signal through the second antenna connected to the second communication module of the wireless controller; sending out an initiate position signal through the first antenna connected to the first communication module of the main apparatus after the main apparatus receiving the prepared position signal through the first antenna; initiating the ultrasonic transmitting module of the wireless controller to send out an ultrasonic signal after the second communication module receiving the initiate position signal through the second antenna; receiving the ultrasonic signal by the first ultrasonic receiving module, the second ultrasonic receiving module and the third ultrasonic receiving module; calculating the received transmission time of the ultrasonic signal and obtaining a coordinate value of the wireless controller by the main apparatus; sending out an accomplished position signal by the first communication module through the first antenna; and receiving the accomplished position signal by the second communication module through the second antenna to finish positioning the wireless controller.

It can be seen that the main apparatus and the wireless controller transmit data to each other with the help of the first communication module, the first antenna, the second communication module and the second antenna. The first ultrasonic receiving module, the second ultrasonic receiving module and the third ultrasonic receiving module receive the ultrasonic signal sent by the ultrasonic transmitting module of the wireless controller. The main apparatus calculates the received transmission time of the ultrasonic signal and obtains the coordinate value of the wireless controller to position the wireless controller. The structure of the position system for interactive gaming device is simplified, and the manufacture cost is reduced. Moreover, the ultrasonic is uneasy to be interfered, so the wireless controller is positioned more precisely. Therefore, the invention attains the aim of overcoming the drawbacks of the prior art.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a position system for interactive gaming device, which is connected to a host of a computer and a display device in accordance with the present invention;

FIG. 2 is a perspective view of a main apparatus of the position system;

FIG. 3 is a circuit block diagram of the main apparatus;

FIG. 4 is a perspective view of a wireless controller of the position system;

FIG. 5 is a circuit block diagram of the wireless controller;

FIG. 6 shows the best range that the wireless controller shifts according to the present invention;

FIG. 7 shows a first time that the main apparatus positions the wireless controller;

FIG. 8 is a flow chart of an embodiment of the first time that the main apparatus positions the wireless controller;

FIG. 9 is a flow chart of another embodiment of the first time that the main apparatus positions the wireless controller;

FIG. 10 shows the main apparatus positioning the wireless controller which is shifted front and rear;

FIG. 11 shows the main apparatus positioning the wireless controller which is shifted left and right;

FIG. 12 shows the main apparatus positioning the wireless controller which is shifted up and down;

FIG. 13 shows the main apparatus positioning the wireless controller which is shifted regularly;

FIG. 14 is a data list of the main apparatus positioning the wireless controller which is shifted regularly;

FIG. 15 shows the main apparatus positioning the wireless controller which is shifted irregularly; and

FIG. 16 is a data list of the main apparatus positioning the wireless controller which is shifted irregularly.

### DETAILED DESCRIPTION OF THE PREFERRED EMBODIMENTS

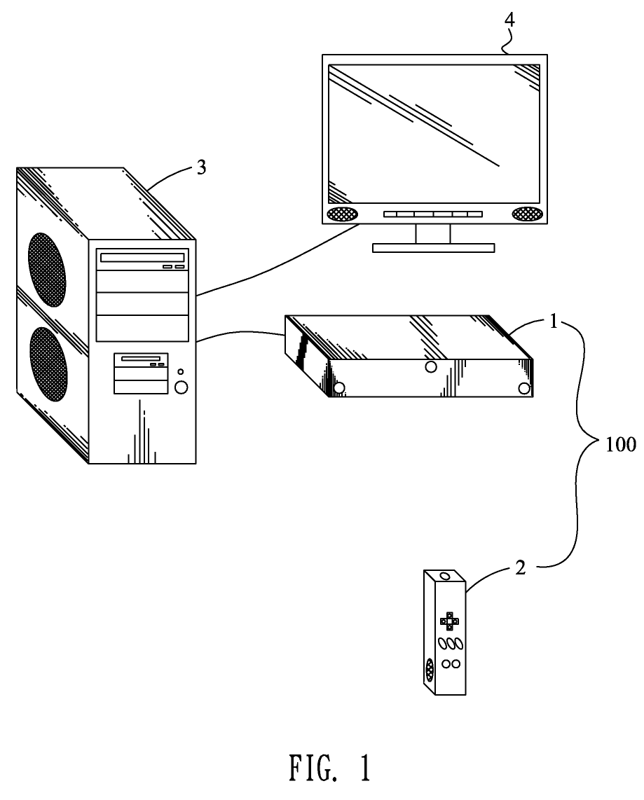

With reference to FIG. 1, a position system for interactive gaming device 100 in accordance with the present invention includes a main apparatus 1 and a wireless controller 2. The main apparatus 1 is connected to an electronic device such as a host of a computer or a gaming device via a connection cord. In the preferred embodiment, the electronic device is a host 3 of a computer. The host 3 is further connected to a display device and the display device is a monitor 4 of the computer in the preferred embodiment. Game software is installed in the host 3, and when a player has a game, the player can control the game process by the wireless controller 2. The main apparatus 1 receives the control signals from the wireless controller 2 and calculates the coordinate values of the wireless controller 2. The main apparatus 1 transmits the control signals and the coordinate values to the game software installed in the host 3 by the connection cord. The game software further controls the game process based on the control signals and the coordinate values of the wireless controller 2, and shows the game process to the player through the monitor 4 connected to the host 3.

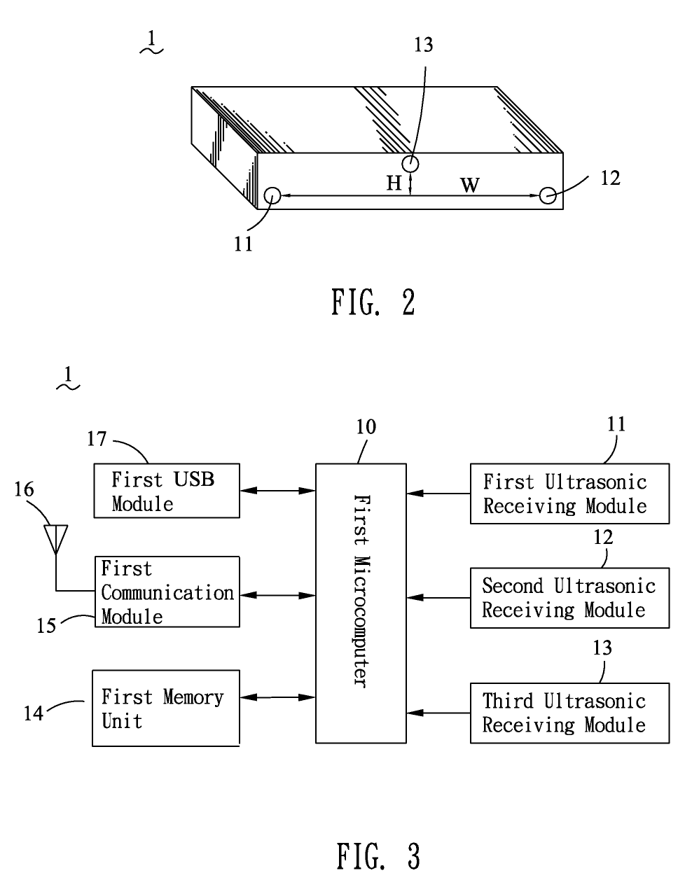

Please refer to FIG. 2 and FIG. 3. FIG. 2 is a perspective view of the main apparatus 1, and FIG. 3 is a circuit block diagram of the main apparatus 1. The main apparatus 1 includes a first microcomputer 10, a first ultrasonic receiving module 11, a second ultrasonic receiving module 12, a third ultrasonic receiving module 13, a first memory unit 14, a first communication module 15, a first antenna 16 and a first USB module 17. All of these will be described in detail hereinafter.

Please refer to FIG. 3 again. The first ultrasonic receiving module 11, the second ultrasonic receiving module 12 and the third ultrasonic receiving module 13 are connected to the first microcomputer 10 respectively, which can transform received ultrasonic signals into data and transmit the data to the first microcomputer 10. The first memory unit 14 connected to the first microcomputer 10 is used for storing data for opening the main apparatus 1. When a power switch of the main apparatus 1 is opened, only when the first microcomputer 10 attains the data for opening the main apparatus 1 from the first memory unit 14, the main apparatus 1 is started to work normally. The first memory unit 14 is also used for storing important data for the first microcomputer 10.

The first communication module 15 connects with the first microcomputer 10 and the first antenna 16 respectively. The first communication module 15 receives and modulates instructions from the first microcomputer 10 into wireless signals, and then sends out the wireless signals via the first antenna 16. The first communication module 15 can also receives and demodulates wireless signals from the first antenna 16 into instructions, and then transmits the instructions to the first microcomputer 10. The main apparatus 1 and the host 3 transmit data to each other via the first USB module 17 connected to the first microcomputer 10 and a connection cable which connects the first USB module 17 to the host 3. Additionally, the host 3 can provide power to the main apparatus 1 through the first USB module 17.

Referring to FIG. 2, the first ultrasonic receiving module 11, the second ultrasonic receiving module 12 and the third ultrasonic receiving module 13 are defined on the main apparatus 1 respectively. The first ultrasonic receiving module 11 and the second ultrasonic receiving module 12 are on the same level and the distance between them is designated W. The third ultrasonic receiving module 13 is defined at the middle of the first ultrasonic receiving module 11 and the second ultrasonic receiving module 12. The distance from the third ultrasonic receiving module 13 to the level defined by the first ultrasonic receiving module 11 and the second ultrasonic receiving module 12 is designated H. So obviously the first ultrasonic receiving module 11, the second ultrasonic receiving module 12 and the third ultrasonic receiving module 13 are not at the same level and form a triangle shape between them. In the preferred embodiment, the value of the W is 20 centimeters, and the value of the H is at the range of 2 centimeters to 5 centimeters. The specific arrangement of the first ultrasonic receiving module 11, the second ultrasonic receiving module 12 and the third ultrasonic receiving module 13 facilitates the main apparatus 1 detecting the up-down displacement, the left-right displacement and the front-rear displacement of the wireless controller 2. Hereinafter, this will be described in detail.

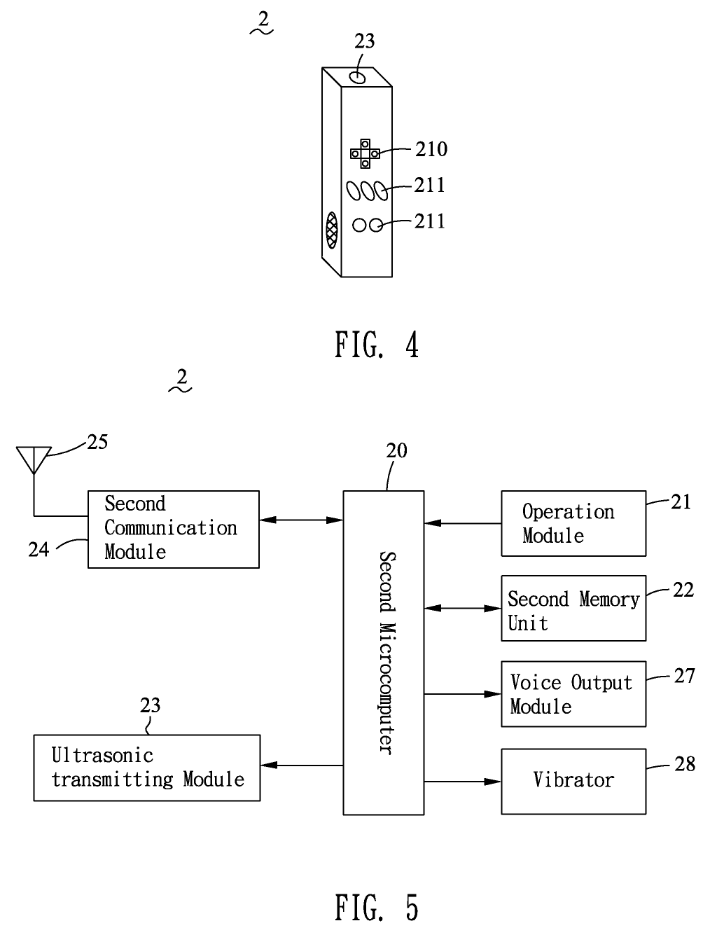

Please refer to FIG. 4 and FIG. 5. FIG. 4 is a perspective view of the wireless controller 2. FIG. 5 is a circuit block diagram of the wireless controller 2. The wireless controller 2 includes a second microcomputer 20, an operation module 21, a second memory unit 22, an ultrasonic transmitting module 23, a second communication module 24, a second antenna 25, a voice output module 27 and a vibrator 28.

With reference to FIG. 4, the operation module 21 includes a cross button 210 and a plurality of control buttons 211 defined on a housing of the wireless controller 2. The cross button 210 and the control buttons 211 are endued with different functions in game. The player can press the buttons to control the game process. The ultrasonic transmitting module 23 is defined on the housing of the wireless controller 2. The ultrasonic transmitting module 23 sends out an ultrasonic signal which is received by the first ultrasonic receiving module 11, the second ultrasonic receiving module 12 and the third ultrasonic receiving module 13 in order to facilitate the main apparatus 1 to position the wireless controller 2.

Referring to FIG. 5, the operation module 21 is connected to the second microcomputer 20. The second microcomputer 20 detects the press state of the cross button 210 and the control buttons 211 and produces corresponding instructions. The second memory unit 22 connected to the second microcomputer 20 is used for storing data for opening the wireless controller 2. When a power switch of the wireless controller 2 is opened, first of all, the second microcomputer 20 collects the data from the second memory unit 22 to start the wireless controller 2 to work normally. Further more, the second memory unit 22 can store important data for the second microcomputer 20.

The ultrasonic transmitting module 23 connected to the second microcomputer 20 sends out an ultrasonic signal according to the instructions which are sent by the second microcomputer 20. The second communication module 24 connects with the second microcomputer 20 and the second antenna 25 respectively. The second communication module 24 receives and modulates instructions from the second microcomputer 20 into wireless signals and then sends out the wireless signals via the second antenna 25. The second communication module 24 can also receives and demodulates wireless signals from the second antenna 25 into instructions, and then transmits the instructions to the second microcomputer 20.

The voice output module 27 and the vibrator 28 are respectively connected to the second microcomputer 20. When the game is going on, the main apparatus 1 sends instructions to the first communication module 15. The first communication module 15 receives and modulates the instructions into wireless signals and sends out the wireless signals by the first antenna 16. The second antenna 25 of the wireless controller 2 receives the wireless signals sent by first antenna 16 of the main apparatus 1, and sends the wireless signals to the second communication module 24. The second communication module 24 receives and demodulates the wireless signals into instructions, and sends the instructions to the second microcomputer 20. The second microcomputer 20 distinguishes the instructions and directs the voice output module 27 and the vibrator 28 to output voice and vibration which improve the fun of the game as if the player were a part of the game.

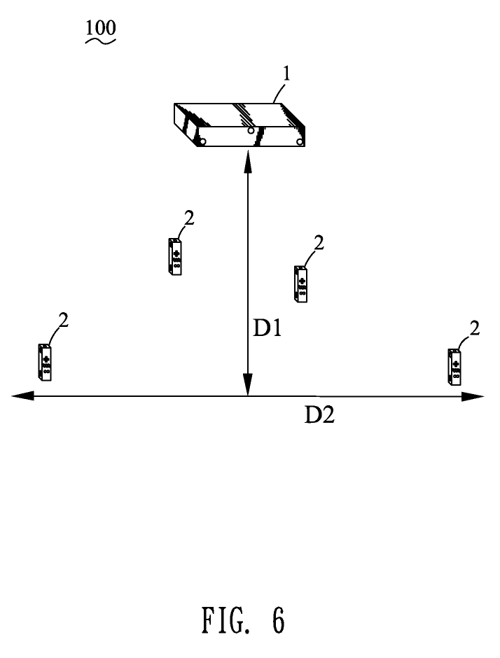

Referring to FIG. 6, after the player starts the main apparatus 1 and the wireless controller 2, the main apparatus 1 begins to position the wireless controller 2, and data is transmitted between the main apparatus 1 and the wireless controller 2. The transmission speed of an ultrasonic wave is 340 m/s on condition that the temperature is 25 degrees and the transmission medium is air. In the process of the main apparatus 1 positioning the wireless controller 2, the wireless controller 2 can be shifted in a better area defined by a longitudinal distance labeled D1 from the main apparatus 1 and a transverse distance labeled D2. In this area, the main apparatus 1 positions the wireless controller 2 precisely. In the preferred embodiment, the value of the D1 is 5 meters, and the value of the D2 is 10.5 meters.

For example, if the distance between the wireless controller 2 and the main apparatus 1 is 2 meters, that is, the value of the D1 is 2 meters, it can be seen that after the wireless controller 2 sends an ultrasonic wave, the time that the main apparatus 1 receives the ultrasonic wave is approximate 5.8 microseconds based on the transmission speed of the ultrasonic wave. However, the ultrasonic transmitting module 23 of the wireless controller 2 needs 1 microsecond to produce an ultrasonic wave. So the wireless controller 2 needs 6.8 microseconds to send an ultrasonic wave.

If the distance between the wireless controller 2 and the main apparatus 1 is 5 meters, that is, the value of the D1 is 5 meters, it can be seen that after the wireless controller 2 sends an ultrasonic wave, the time that the main apparatus 1 receives the ultrasonic wave is approximate 14.7 microseconds according to the transmission speed of the ultrasonic wave. That is, if the number of the wireless controller 2 increases, the times of the main apparatus 1 detecting the position of every wireless controller 2 decreases correspondingly.

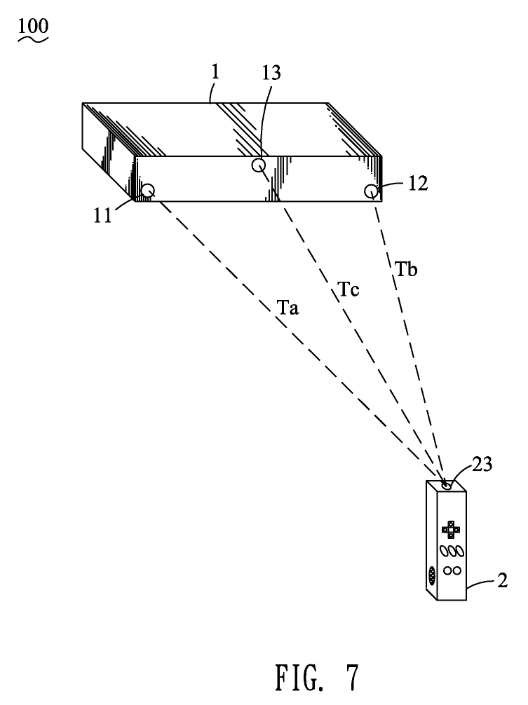

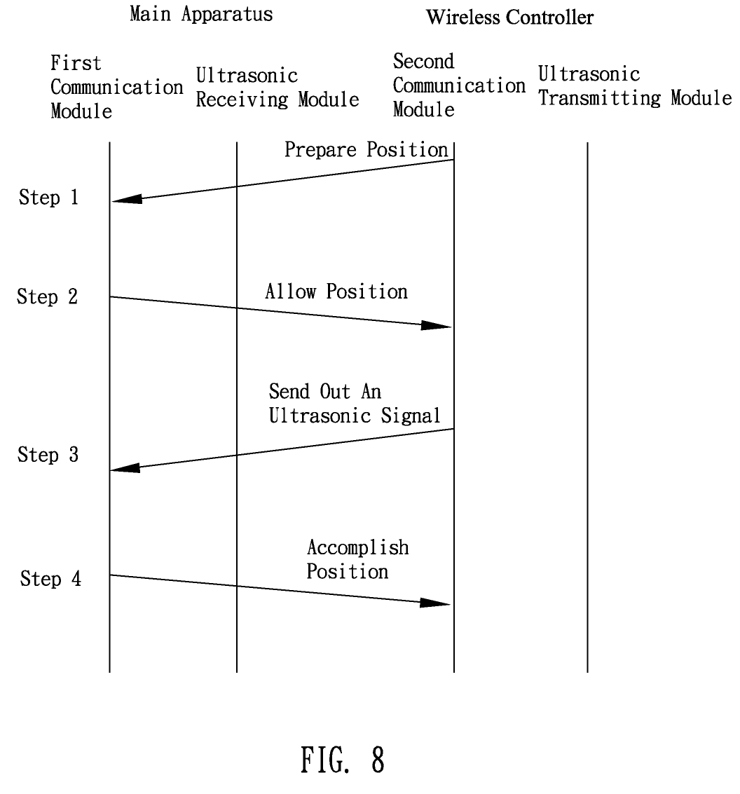

Please refer to FIG. 7 and FIG. 8. FIG. 7 shows the first time that the main apparatus 1 positions the wireless controller 2. FIG. 8 is a flow chart of an embodiment of the first time that the main apparatus 1 positions the wireless controller 2. In this embodiment, a method for positioning the wireless controller 2 of the interactive gaming device is described as follows:
1) After the wireless controller 2 is opened and starts to work, the player presses the cross button 210 or the control buttons 211. Then, the second microcomputer 20 detects the press state of the buttons, and then sends a prepared position instruction which means preparing to be positioned to the second communication module 24. The second communication module 24 receives the prepared position instruction and modulates the position instruction into a wireless signal which is sent out by the second antenna 25.
2) The first antenna 16 of the main apparatus 1 receives the wireless signal sent by the wireless controller 2 and transmits the wireless signal to the first communication module 15. The first communication module 15 receives and demodulates the wireless signal into an instruction, and sends the instruction to the first microcomputer 10. The first microcomputer 10 tests the instruction to confirm that the instruction is right. Then the first microcomputer 10 sends an initiate position instruction to the first communication module 15. The first communication module 15 receives the initiate position instruction and modulates the initiate position instruction into an initiate position wireless signal which is sent out by the first antenna 16.
3) When the second antenna 25 receives the initiate position wireless signal, the initiate position wireless signal is sent to the second communication module 24. The second communication module 24 receives and demodulates the initiate position wireless signal into an initiate position instruction, and sends the initiate position instruction to the second microcomputer 20. The second microcomputer 20 receives and tests the initiate position instruction. If the initiate position instruction is accurate, the second microcomputer 20 orders the ultrasonic transmitting module 23 to send out an ultrasonic signal.
4) The first ultrasonic receiving module 11, the second ultrasonic receiving module 12 and the third ultrasonic receiving module 13 respectively receive the ultrasonic signal sent by the wireless controller 2. The transmission time of the ultrasonic signal to the three ultrasonic receiving modules 11, 12, 13 are labeled Ta, Th, Tc respectively. The first microcomputer 10 calculates the beeline distances between the wireless controller 2 and the first ultrasonic receiving module 11, the second ultrasonic receiving module 12, the third ultrasonic receiving module 13 according to the transmission characteristic of the ultrasonic wave after receiving the time Ta, Tb, Tc information. Then the main apparatus 1 attains a coordinate value of the wireless controller 2 and positions the wireless controller 2. After then, the main apparatus 1 considers the coordinate value as a basic point, and sends a complete position instruction to the first communication module 15. The first communication module 15 receives and modulates the complete position instruction into a complete position signal sent out by the first antenna 16. The second antenna 25 receives and transmits the complete position signal sent by the main apparatus 1 to the second communication module 24. The second communication module 24 receives and demodulates the complete position signal into the complete position instruction, and transmits the complete position instruction to the second microcomputer 20. Then the second microcomputer 20 tests the instruction and confirms that the complete position instruction is right. The first time that the main apparatus 1 positions the wireless controller 2 is accomplished.

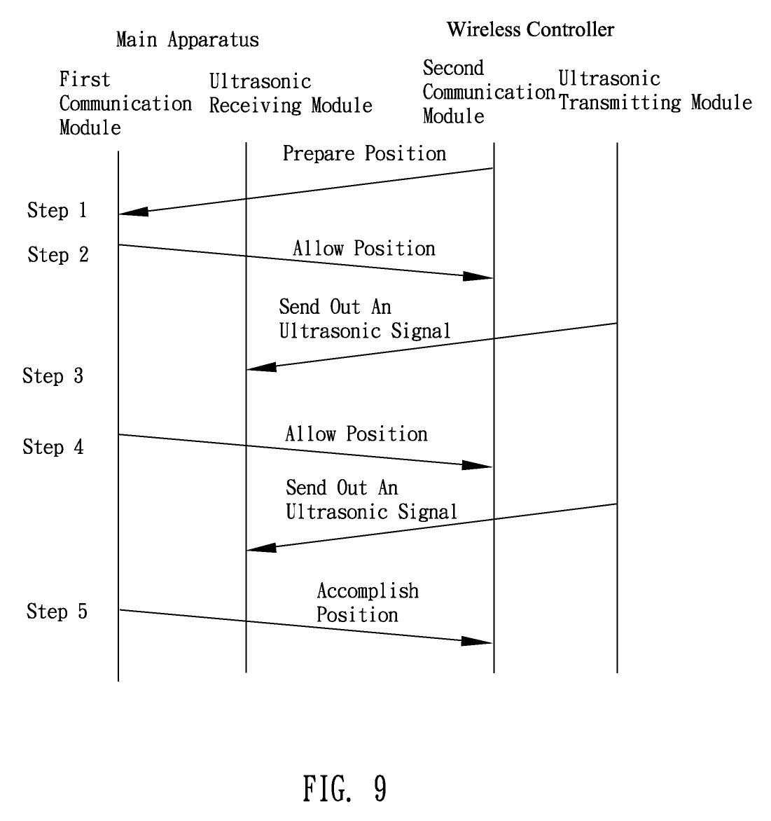

Please refer to FIG. 9, which is a flow chart of another embodiment of the first time that the main apparatus 1 positions the wireless controller 2. In this embodiment, the method that main apparatus 1 positions the wireless controller 2 is described as follows:
1) After the wireless controller 2 is opened and starts to work, the player presses the cross button 210 or the control buttons 211. Then, the second microcomputer 20 detects the press state of the buttons, and sends a prepared position instruction which means preparing to be positioned to the second communication module 24. The second communication module 24 receives the prepared position instruction and modulates the position instruction into a wireless signal which is sent out by the second antenna 25.
2) The first antenna 16 of the main apparatus 1 receives the wireless signal sent by the wireless controller 2 and transmits the wireless signal to the first communication module 15. The first communication module 15 demodulates the wireless signal into an instruction, and sends the instruction to the first microcomputer 10. The first microcomputer 10 tests the instruction to confirm that the instruction is right. Then the first microcomputer 10 sends an initiate position instruction to the first communication module 15. The first communication module 15 receives the initiate position instruction and modulates the initiate position instruction into an initiate position wireless signal. The first antenna 16 sends out the initiate position wireless signal, and at the same time, the first microcomputer 10 starts a procedure for timing.
3) When the second antenna 25 receives and sends the initiate position wireless signal to the second communication module 24. The second communication module 24 receives and demodulates the initiate position wireless signal into an initiate position instruction, and sends the initiate position instruction to the second microcomputer 20. The second microcomputer 20 receives and tests the initiate position instruction. If the initiate position instruction is accurate, the second microcomputer 20 orders the ultrasonic transmitting module 23 to send out an ultrasonic signal.
4) If the time exceeds a predetermined value and simultaneously the main apparatus 1 doesn't receive the ultrasonic signal sent by the wireless controller 2, the main apparatus 1 will send out the initiate position signal again.
5) The first ultrasonic receiving module 11, the second ultrasonic receiving module 12 and the third ultrasonic receiving module 13 respectively receive the ultrasonic signal sent by the wireless controller 2. The transmission time of the ultrasonic signal to the three ultrasonic receiving modules 11, 12, 13 is designated Ta, Tb, Tc respectively. The first microcomputer 10 calculates the beeline distances between the wireless controller 2 and the three ultrasonic receiving modules 11, 12, 13 according to the transmission characteristic of the ultrasonic wave after receiving the time Ta, Tb, Tc information. Then the main apparatus 1 attains a coordinate value of the wireless controller 2 and positions the wireless controller 2. After then, the main apparatus 1 considers the coordinate value as a basic point and sends a complete position instruction to the first communication module 15. The first communication module 15 receives and modulates the complete position instruction into a complete position signal sent out by the first antenna 16. The second antenna 25 receives and transmits the complete position signal sent by the main apparatus 1 to the second communication module 24. The second communication module 24 receives and demodulates the complete position signal into the complete position instruction, and transmits the complete position instruction to the second microcomputer 20. Then the second microcomputer 20 tests the instruction and confirms that the instruction is right. The first time that the main apparatus 1 positions the wireless controller 2 is accomplished.

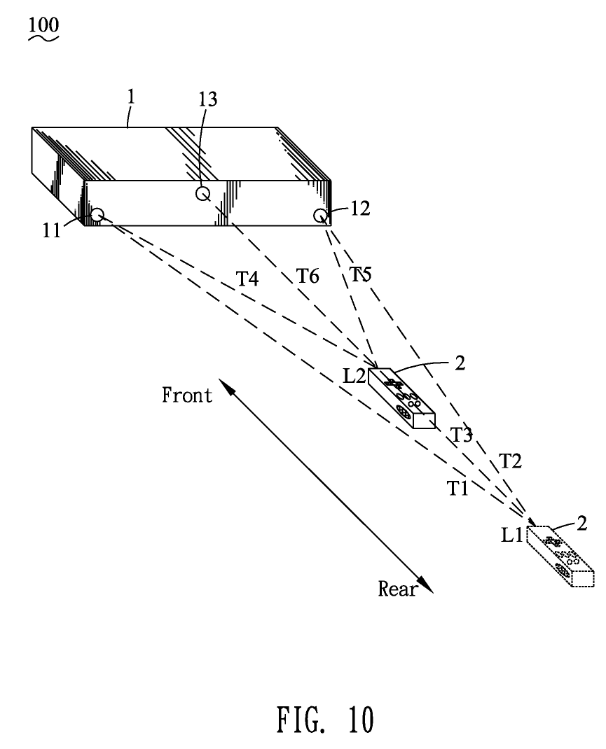

With reference to FIG. 10, when the game is going on, the player shifts the wireless controller 2 front and rear, and the wireless controller 2 sends ultrasonic waves continually. If the wireless controller 2 is disposed at the place designated L1 and sends out an ultrasonic signal, the first ultrasonic receiving module 11, the second ultrasonic receiving module 12 and the third ultrasonic receiving module 13 receive the ultrasonic signal, spending the time designated T1, T2, T3 respectively. The first microcomputer 10 calculates the beeline distances between the wireless controller 2 and the three ultrasonic receiving modules 11, 12, 13 according to the transmission characteristic of the ultrasonic wave after receiving the time T1, T2, T3 information. Then the main apparatus 1 attains a coordinate value of the L1 and positions the wireless controller 2.

If the wireless controller 2 is shifted to the place designated L2 and sends out an ultrasonic signal, the first ultrasonic receiving module 11, the second ultrasonic receiving module 12 and the third ultrasonic receiving module 13 receive the ultrasonic signal, spending the time designated T4, T5, T6 respectively. The first microcomputer 10 calculates the beeline distances between the wireless controller 2 and the three ultrasonic receiving modules 11, 12, 13 according to the transmission characteristic of the ultrasonic wave after receiving the time T4, T5, T6 information. Compared to the coordinate value of the L1, then the main apparatus 1 attains a coordinate value of the L2 and positions the wireless controller 2.

After the first microcomputer 10 attains the coordinate values of the L1, L2, the first microcomputer 10 transmits the coordinate values of the L1, L2 to the game software installed in the host 3 through the first USB module 17. The game software displays the coordinate values of the L1, L2 via the monitor 4 to the player. Then an object which the player controls will be shifted front and rear in the game image displayed in the monitor 4.

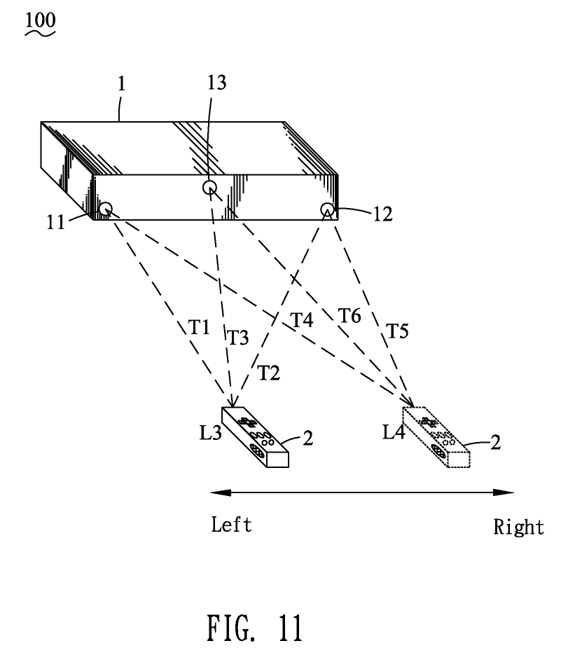

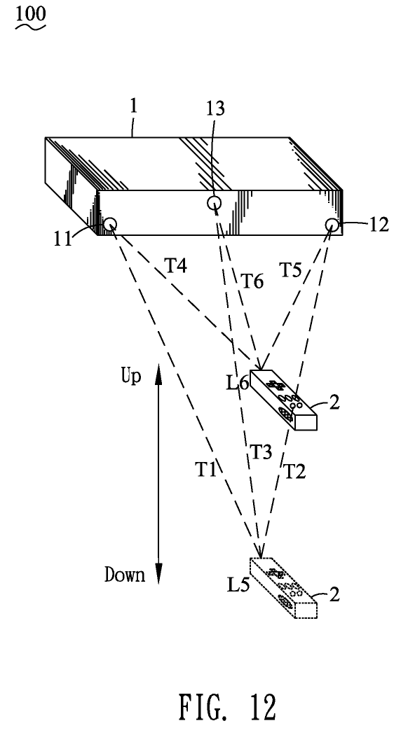

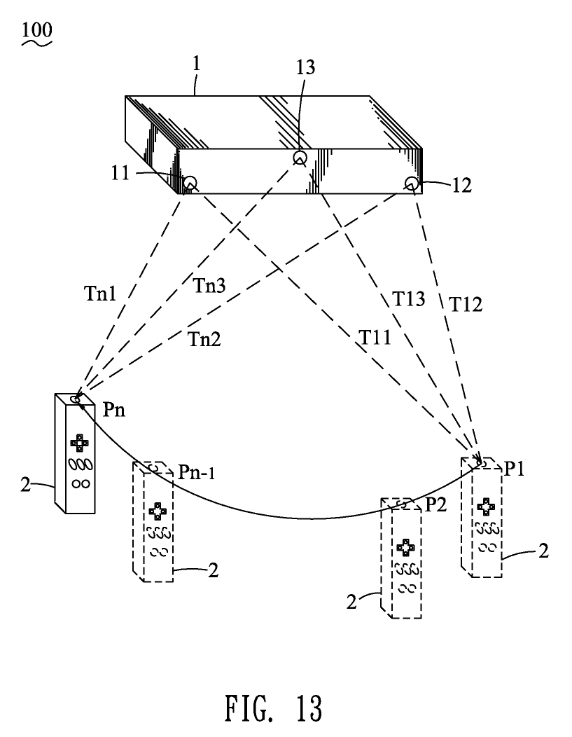

Please refer to FIG. 11 and FIG. 12 showing the wireless controller 2 shifted left and right, and up and down. As described above, when the wireless controller 2 is shifted from left designated L3 to right designated L4 or from right to left, or when the wireless controller 2 is shifted from up designated L6 to down designated L5 or from down to up, the three ultrasonic receiving modules 11, 12, 13 respectively receive an ultrasonic signal sent by the wireless controller 2, spending the time labeled T1, T2, T3, T4, T5, T6. The main apparatus 1 calculates the beeline distances between the wireless controller 2 and the three ultrasonic receiving modules 11, 12, 13 after receiving the time T1, T2, T3, T4, T5, T6 information. Then the main apparatus 1 attains coordinate values of the L3, L4, L5, and L6.

After the first microcomputer 10 attains the coordinate values of the L3, L4, L5, and L6, the first microcomputer 10 transmits the coordinate values to the game software through the first USB module 17. The game software displays the coordinate values via the monitor 4. Then the object which the player controls will be shifted left and right or up and down in the game image displayed in the monitor 4.

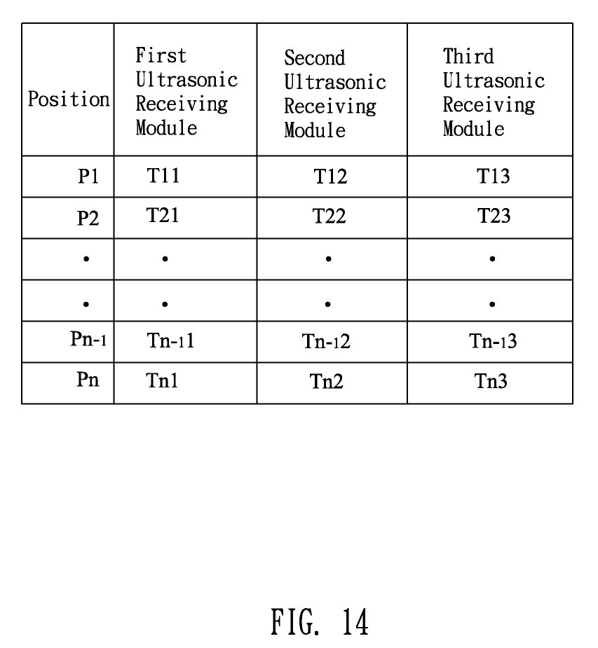

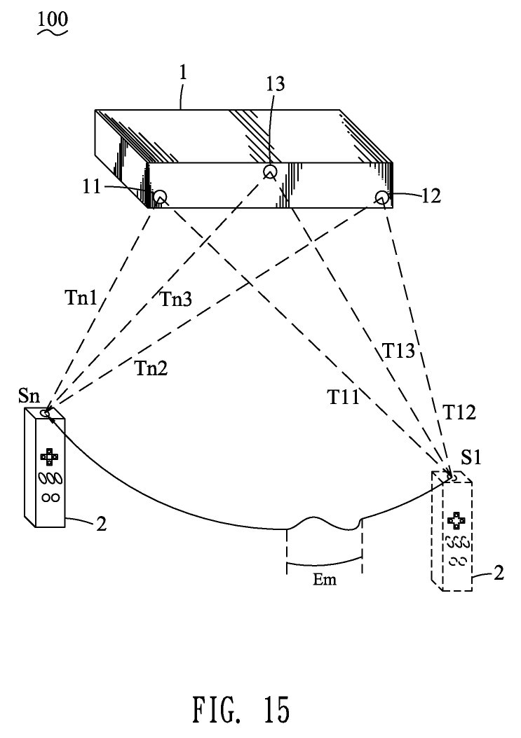

Please refer to FIG. 13 and FIG. 14. When the wireless controller 2 is shifted from PI to Pn with sending ultrasonic signals continually, the main apparatus 1 receives the ultrasonic signals in turn and calculates coordinate values of the PI to Pn.

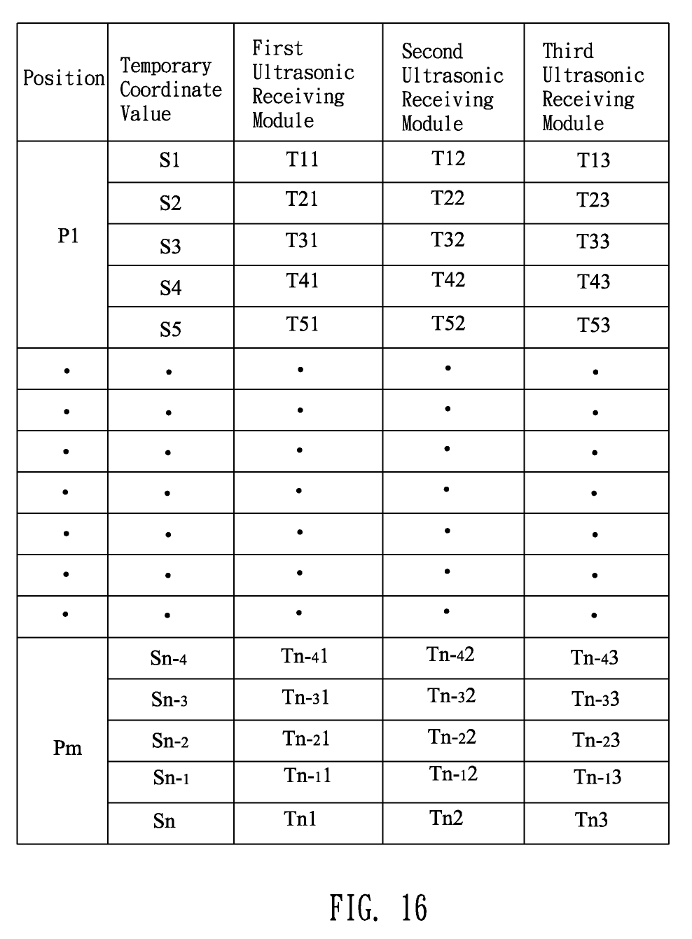

Referring to FIG. 15 to FIG. 16, if the wireless controller 2 is shifted form the S1 to Sn with some irregular shift Em therein, in order to avoid wrong directions to the game program brought by the irregular shift Em, the first microcomputer 10 of the main apparatus 1 calculates the coordinate values of the wireless controller 2 and temporarily stores the coordinate values designated S1 to Sn. Then, the main apparatus 1 calculates the average coordinate values designated PI to Pm in turn based on the coordinate values S1 to Sn, and considers the average coordinate values PI to Pm as the virtual coordinate values of the wireless controller 2. The first microcomputer 10 transmits the average coordinate values PI to Pm to the game software to eliminate wrong directions to the game program brought by the irregular shift Em.

As described above, the first ultrasonic receiving module 11, the second ultrasonic receiving module 12 and the third ultrasonic receiving module 13 respectively receive the ultrasonic signal sent by ultrasonic wave transmission module 23 of the wireless controller 2 and transmit the ultrasonic signal to the first microcomputer 10 of the main apparatus 1 to calculate the coordinate value of the wireless controller 2. Therefore, the position system for interactive gaming device 100 positions the wireless controller 2 precisely. Further more, the main apparatus 1 and the wireless controller 2 transmit data to each other through the first wireless communication module 15, the first antenna 16, the second wireless communication module 24, and the second antenna 25. So the voice output module 27 and the vibrator 28 can attain instructions from the main apparatus 1 and output voice and vibration along with the game process to increase the real sense of the game.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A position system for interactive gaming device, comprising:
a wireless controller, including an ultrasonic transmitting module; and
a main apparatus, including a first microcomputer, a first ultrasonic receiving module, a second ultrasonic receiving module and a third ultrasonic receiving module, the first ultrasonic receiving module having a distance from the second ultrasonic receiving module, the third ultrasonic receiving module having a distance form the first ultrasonic receiving module and the second ultrasonic receiving module, the three ultrasonic receiving modules forming a triangle shape, the three ultrasonic receiving modules receiving ultrasonic signals sent by the ultrasonic transmitting module of the wireless controller, the first microcomputer calculating the received transmission times of the ultrasonic signals and obtaining a plurality of coordinate values indicating the motion track of the wireless controller, and further recognizing the positions of the wireless controller.

2. The position system for interactive gaming device as claimed in claim 1, further comprising an electronic device connected to the main apparatus and a display device connected to the electronic device, the electronic device receiving the coordinate values of the wireless controller from the main apparatus, and showing the movement of the wireless controller on the display device by monitoring the coordinate values.

3. The position system for interactive gaming device as claimed in claim 1, wherein the first ultrasonic receiving module and the second ultrasonic receiving module are on the same surface level, the third ultrasonic receiving module is defined at the middle of the first and second ultrasonic receiving modules and has a distance from the surface level defined by the first and second ultrasonic receiving modules.

4. The position system for interactive gaming device as claimed in claim 2, wherein the main apparatus further includes a first USB module, a first communication module, a first antenna and a first memory unit, the first USB module is used for transmitting or receiving data between the main apparatus and the electronic device, the first communication module connected to the first antenna is used for transmitting or receiving control signals between the main apparatus and the wireless controller, the first memory unit stores the data capable of driving the main apparatus startup, wherein the wireless controller includes a second microcomputer, an operation module, a second memory unit, a second communication module, and a second antenna, the second microcomputer connects to the operation module and produces corresponding instructions accompanying the press state of the operation module, the second memory unit stores the data for driving the wireless controller startup, the second communication module connecting the second antenna is used for transmitting and receiving control signals between the main apparatus and the wireless controller.

5. The position system for interactive gaming device as claimed in claim 4, wherein the wireless controller further includes a voice output module and a vibrator, a control signal received by the wireless controller from the main apparatus brings the voice output module and the vibrator output voice and vibration respectively.

6. A method for positioning the wireless controller of the interactive gaming device, comprising the steps of:
sending out a prepared position signal through a second antenna connected to a second communication module of the wireless controller;
sending out an initiate position signal via a first antenna connected to a first communication module of the main apparatus after the main apparatus receiving the prepared position signal through the first antenna;
initiating the ultrasonic transmitting module to send out an ultrasonic signal after the second communication module receiving the initiate position signal through the second antenna;
receiving the ultrasonic signal by the first ultrasonic receiving module, the second ultrasonic receiving module and the third ultrasonic receiving module;
calculating the received transmission time of the ultrasonic signal and obtaining a coordinate value by a first microcomputer;
sending out an accomplished position signal by the first communication module through the first antenna; and
receiving the accomplished position signal by the second communication module through the second antenna for finishing the position of the wireless controller.

7. The method for positioning the wireless controller of the interactive gaming device as claimed in claim 6, wherein the main apparatus sends out the initiate position signal and at the same time starts a procedure for timing, if the time exceeds a predetermined value and simultaneously the main apparatus doesn't receive the ultrasonic signal sent by the wireless controller, the main apparatus sends out the initiate position signal again.

8. The method for positioning the wireless controller of the interactive gaming device as claimed in claim 6, wherein a second microcomputer of the wireless controller detects the press state of the buttons and sends out a prepared position instruction to the second communication module which receives and modulates the prepared position instruction into the prepared position signal, the prepared position signal is sent out by the second antenna, wherein the main apparatus receives the prepared position signal sent by the wireless controller, the first communication module demodulates the prepared position signal into the prepared position instruction, and transmits the instruction to the first microcomputer, the first microcomputer tests the instruction, and if the instruction is right, the first microcomputer sends an initiate position instruction to the first communication module, the first communication module modulates the initiate position instruction into the initiate position signal, and sends out the initiate position signal through the first antenna, wherein the wireless controller receives the initiate position signal which is demodulated into the initiate position instruction by the second communication module, the instruction is transmitted to the second microcomputer, the second microcomputer tests the instruction, and if the instruction is right, the second microcomputer initiates the ultrasonic transmitting module to send the ultrasonic signal, wherein the three ultrasonic receiving modules receive the ultrasonic signal sent by the wireless controller, the first microcomputer calculates the beeline distance between the wireless controller and the main apparatus basing on the received transmission time of the three ultrasonic receiving modules and transmission characteristic of the ultrasonic, and obtains a coordinate value of the wireless controller.

9. The method for positioning the wireless controller of the interactive gaming device as claimed in claim 6, wherein when the ultrasonic transmitting module sends one ultrasonic signal, correspondingly, the main apparatus attains one coordinate value of the wireless controller.

10. The method for positioning the wireless controller of the interactive gaming device as claimed in claim 6, wherein the main apparatus receives a set of ultrasonic signals which is defined in advance from the wireless controller, the main apparatus attains one coordinate value of the wireless controller.
